(19) United States
(12) Patent Application Publication
(10) Pub. No.: US 2013/0124632 A1
(43) Pub. Date: May 16, 2013

(54) TERMINAL DEVICE, INFORMATION PROCESSING METHOD, PROGRAM, AND STORAGE MEDIUM

(71) Applicant: Sony Corporation, Tokyo (JP)

(72) Inventors: Keiko SAEKI, Kanagawa (JP); Takayuki TSUZUKI, Tokyo (JP); Shinya MARUYAMA, Tokyo (JP)

(73) Assignee: Sony Corporation, Tokyo (JP)

(21) Appl. No.: 13/672,872

(22) Filed: Nov. 9, 2012

(30) Foreign Application Priority Data
Nov. 16, 2011 (JP) 2011-250636

(51) Int. Cl. H04L 29/08

(52) U.S. Cl. CPC H04L 67/26
USPC 709/204

(57) ABSTRACT

A terminal device includes an acquisition unit configured to acquire time information and position information, and a generation unit configured to generate an action identification based on acquired pieces of the time information and acquired pieces of the position information.

### BACKGROUND

The present disclosure relates to a terminal device, an information processing method, a program, and a storage medium, and particularly relates to a terminal device, an information processing method, a program, and a storage medium which allow, for example, only people who belong to the same group and have travelled together to share a picture taken during the travel.

For example, there is considered a case where pictures are shared only between people who belong to the same group and act together, e.g., travel together, where the pictures are individually taken by the people during the action. In that case, a method is considered in which a member of the group individually upload picture data to a certain server and inform the other members belonging to the group of a password, etc. to view the picture data, or upload the picture data to a certain shared server, for example, as disclosed in Japanese Unexamined Patent Application Publication No. 2009-282734.

### SUMMARY

As described above, when allowing only members who belong to a particular group to upload picture data to a certain server and share the picture data among the members, a common password, etc. may be used. However, it is troublesome for members of the group to manage the password and notify the members of the common password, etc. Further, there is a risk of the common password, etc. being accidentally leaked to other people, which makes it difficult to protect privacy or copyright.

Accordingly, it is desirable to share content data such as picture data only between people who belong to a group and act together.

A terminal device according to an embodiment of the present disclosure includes an acquisition unit configured to acquire time information and position information, and a generation unit configured to generate an action ID based on acquired pieces of the time information and acquired pieces of the position information.

The terminal device according to the embodiment of the present disclosure may further include a transmission unit configured to notify an external device of the generated action ID, and transmit content data to the external device. The external device registers content data transmitted from different terminal devices in association with a same action ID that the external device is notified from the respective terminal devices.

The terminal device according to the embodiment of the present disclosure may further include a reproducing unit configured to acquire and reproduce the content data registered in the external device, the content data being associated with the action ID.

The terminal device according to the embodiment of the present disclosure may further include an image pickup unit configured to generate image data, and a holding unit configured to hold the generated image data. The transmission unit notifies the external device of the generated action ID, and transmits the image data held in the holding unit to the external device as the content data.

The terminal device according to the embodiment of the present disclosure may further include a measuring unit configured to measure the position information. The acquisition unit acquires the position information measured by the measuring unit.

In the terminal device according to the embodiment of the present disclosure, the content data is content data of which use is restricted based on the action ID.

The terminal device according to the embodiment of the present disclosure may further include an obtaining unit configured to obtain content data stored in a storage medium, and a reproducing unit configured to reproduce content data. The reproducing unit determines based on the generated action ID whether or not to reproduce the content data.

The terminal device according to the embodiment of the present disclosure may further include a transmission unit configured to transmit a first generated action ID and content data to a different device belonging to a home network, a reception unit configured to receive from the different device a second action ID that the different device has, and a comparison unit configured to compare the first action ID and the second action ID. When the first and second action IDs agree with each other, the content data is shared between the different device and the terminal device.

An information processing method according to an embodiment of the present disclosure, which is used for a terminal device, includes causing the terminal device to acquire time information and position information, and causing the terminal device to generate an action ID based on acquired pieces of the time information and acquired pieces of the position information.

A program according to an embodiment of the present disclosure causes a computer to function as an acquisition unit configured to acquire time information and position information, and a generation unit configured to generate an action ID based on acquired pieces of the time information and acquired pieces of the position information.

A storage medium according to an embodiment of the present disclosure stores a program causing a computer to function as an acquisition unit configured to acquire time information and position information, and a generation unit configured to generate an action ID based on acquired pieces of the time information and acquired pieces of the position information.

According to an embodiment of the present disclosure, time information and position information are acquired and an action ID is generated based on acquired pieces of the time information and acquired pieces of the position information.

According to an embodiment of the present disclosure, content data such as picture data may be shared only between people who belong to a group and act together.

### BRIEF DESCRIPTION OF THE DRAWINGS

FIG. 1 is a block diagram illustrating an exemplary configuration of an image sharing system according to an embodiment of the present disclosure;

FIG. 2 is a block diagram illustrating an exemplary configuration of a terminal device according to an embodiment of the present disclosure;

FIG. 3 is a flowchart illustrating a process that is performed by the terminal device; and

FIG. 4 is a block diagram illustrating an exemplary configuration of a computer.

### DETAILED DESCRIPTION OF EMBODIMENTS

Hereinafter, the best modes of accomplishing the present disclosure (hereinafter referred to as embodiments) will be described in detail with reference to the attached drawings.

### [Exemplary Configuration of Image Sharing System]

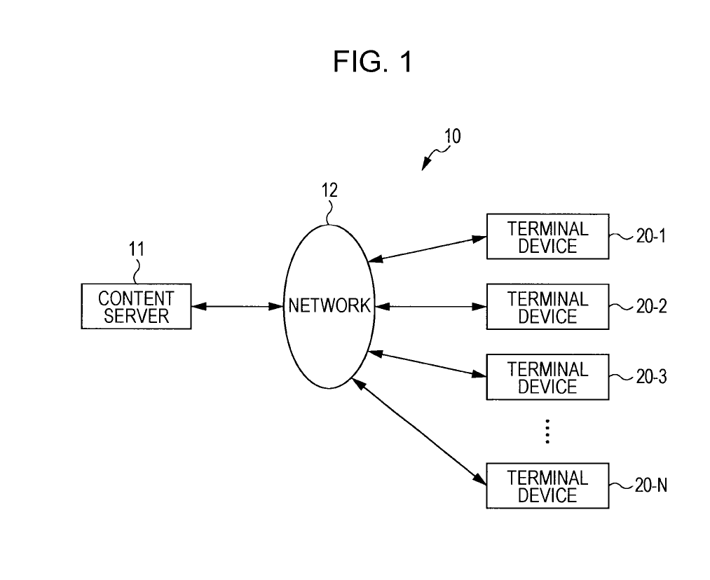

FIG. 1 illustrates an exemplary configuration of an image sharing system 10 according to an embodiment of the present disclosure. The image sharing system 10 includes a content server 11 and plural terminal devices 20-1 to 20-N that are connected to the content server 11 via a network 12.

The content server 11 holds and registers image data of pictures (hereinafter simply referred to as image data), which are uploaded from the terminal devices 20-1 to 20-N, in association with action identifications (IDs) that are received from the terminal devices 20-1 to 20-N. The action IDs will be described later. Here, when the action IDs that are received from the different terminal devices 20-1 to 20-N are equivalent to one another, the image data that are uploaded from the different terminal devices 20-1 to 20-N are integrated into a single image data group with regard to the equivalent action ID, and held and registered.

Further, in response to requests from the terminal devices 20-1 to 20-N that notify the content server 11 of action IDs, the content server 11 allows the terminal devices 20-1 to 20-N to access only an image data group which is held in association with the action IDs.

Further, any content data such as image data other than pictures, video data, audio data, or an application program, which is transmitted from the terminal devices 20-1 to 20-N, can be registered in the content server 11 in association with an action ID.

The network 12 is a communications network allowing bidirectional communications and includes the Internet, a mobile phone network, etc.

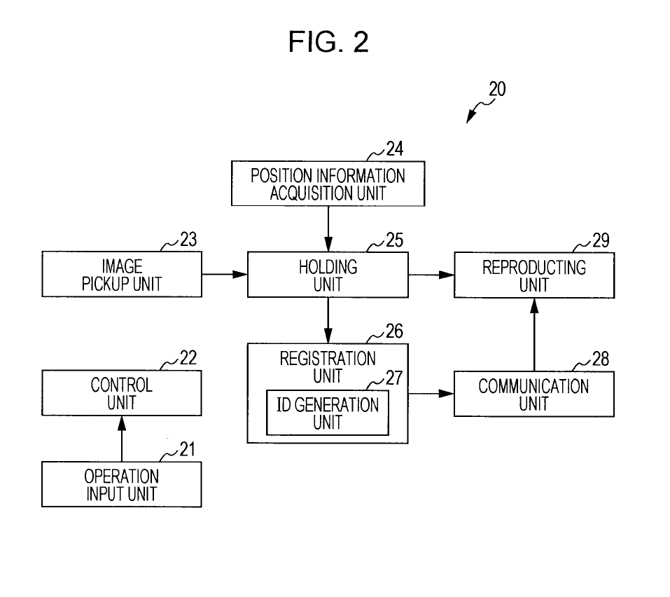

The terminal devices 20-1 to 20-N are individually carried by persons who belong to a group and act together during the action. The terminal devices 20-1 to 20-N may be a portable electronic device including a digital still camera, a digital video camera, a mobile phone, a smartphone, a game machine, a tablet computer, a note computer, a hand-held computer, and so forth, and includes at least components that are illustrated in FIG. 2. Hereinafter, the terminal devices 20-1 to 20-N will be simply referred to as a terminal device 20 or terminal devices 20 when they are not distinguished from one another.

### [Exemplary Configuration of Terminal Device]

FIG. 2 illustrates an exemplary configuration of the terminal device 20 that includes an operation input unit 21, a control unit 22, an image pickup unit 23, a position information acquisition unit 24, a holding unit 25, a registration unit 26, an ID generation unit 27, a communication unit 29, and a reproducing unit 29.

The operation input unit 21 accepts various operations including a shutter operation, an operation to select upload image data, etc., which are performed by a user, and outputs signals corresponding to the operations to the control unit 22. In accordance with the operations, the control unit 22 controls each unit of the terminal device 20.

The image pickup unit 23 captures at least one of a still image or video, and outputs image data obtained as the captured result to the holding unit 25.

The position information acquisition unit 24 measures the current position of the terminal device 20 by receiving a global positioning system (GPS) signal in accordance with the time of capturing by the image pickup unit 23, and outputs information about the time and the position (the latitude and the longitude) of the measurement to the holding unit 25.

Without being limited to the method of receiving a GPS signal, the position may be measured according to any method. For example, the position may be measured based on information about the position of a WiFi spot, using a radio wave emitted from a mobile base station, etc.

Further, the position information acquisition unit 24 might not acquire the time information and the position information. In that case, an external device such as a GPS reception unit connected to the position information acquisition unit 24 may acquire the time information and the position information.

The holding unit 25 stores the image data transmitted from the image pickup unit 23 in association with the time information and the position information that are received from the position information acquisition unit 24.

The registration unit 26 registers (uploads) an action ID generated by the ID generation unit 27 included therein and an image data group selected by the user in the content server 11 via the communication unit 28 and the network 12. The image data group is selected by the user as the target to be uploaded to the content server 11 from among the image data stored in the holding unit 25.

The ID generation unit 27 generates an action ID based on the time information and the position information of image data belonging to the image data group selected by the user from among the image data held in the holding unit 25 as the target for being uploaded to the content server 11. Further, the ID generation unit 27 holds the generated action ID.

When members of a group to which the user of the terminal device 20 belongs act together and pieces of image data that are captured during the action are selected as the upload target, the time information and the position information of the pieces of image data are sorted into groups according to a certain criterion. More specifically, the time information and the position information are sorted into the following groups, for example.

Action taken on Oct. 1, 2011

First spot: around Tokyo Tower from 09:00 to 10:00 (latitude: 35 degrees 65 minutes, longitude: 139 degrees 75 minutes)

Second spot: around Ginza from 10:30 to 14:00 (latitude: 35 degrees 40 minutes, longitude: 139 degrees 45 minutes)

Third spot: around the Imperial Palace from 14:30 to 16:00 (latitude: 35 degrees 41 minutes, longitude: 139 degrees 45 minutes)

Fourth spot: around the Ueno Zoo from 16:00 to 18:00 (latitude: 35 degrees 42 minutes, longitude: 139 degrees 46 minutes)

In that case, an action ID is generated based on the time information and the position information of the four spots. More specifically, the action ID is calculated according to the following calculations:

Message=First spot (latitude+longitude+From+To)+Second spot (latitude+longitude+From+To)+ . . . , and

Action ID=Message−Digest(Message)

where From denotes the number of seconds that elapse before the stay starting time (Oct. 1, 2011 at 09:00 on the first spot) with reference to specified time (e.g., UTC Jan. 1, 1970 at 00:00:00), and To denotes the number of seconds that elapse before the stay finishing time (Oct. 1, 2011 at 10:00 on the first spot) with reference to the specified time.

Further, Message−Digest(Message) denotes a calculation to generate a fixed-length pseudorandom number based on a given original, where a keyed-hash is used. As a Hash algorithm, SHA-256 or the like is used, and a key varies from one service to another.

When the members of a group act together and image data captured during the action is selected as the target to be uploaded in respective terminal devices 20 of the members, the same action ID is generated in each of the terminal devices 20. In other words, the action ID is generated not for information about a position given as a point, but for information about a position given as a set of plural points. Accordingly, even though there are other people at a few spots in the destinations of the group, where the people do not belong to the group and have accidentally moved to the few spots in the same time zones as the group moved, the same action ID is not generated for the people unless their entire visits including the time zones agree with those of the group.

The communication unit 28 transmits the image data group and the action ID that are transmitted from the registration unit 26 to the content server 11 via the network 12. Further, in response to a request issued from the reproducing unit 29, the communication unit 28 notifies via the network 12 the content server 11 of an action ID held in the ID generation unit 27.

The reproducing unit 29 reproduces and displays image data that is captured by the terminal device 20 and stored in the holding unit 25. Further, the reproducing unit 29 accesses an image data group with access permission from the content server 11 via the communication unit 29 and the network 12, and reproduces and displays image data acquired from the image data group. Accordingly, it becomes possible to reproduce and display image data that is captured by the terminal device 20 of another user who acted together with the user of the above-described terminal device 20 and that is uploaded to the content server 11.

### [Description of Operations]

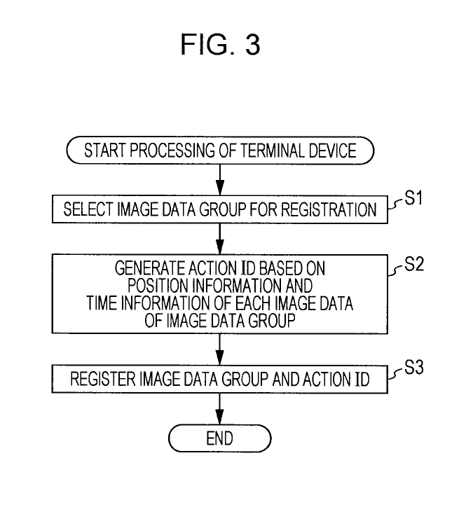

Next, a process that is performed by the terminal device 20 will be described with reference to a flowchart of FIG. 3.

When the user performs an operation at step S1 to select image data to upload, the operation input unit 21 outputs the corresponding operation signal to the control unit 22. In accordance with the selection operation, the control unit 22 controls operations that are performed thereafter by the units of the terminal device 20.

At step S2, the ID generation unit 27 generates an action ID based on the time information and the position information of image data belonging to an image data group selected by the user as the target to be uploaded from among the image data held in the holding unit 25.

At step S3, the registration unit 26 registers (uploads) the generated action ID and the image data group selected as the upload target in the content server 11 via the communication unit 28 and the network 12.

Accordingly, the image data group selected as the upload target in association with the action ID is registered in the content server 11. Further, when the same action ID and an image data group are transmitted from another terminal device 20, plural image data groups that are uploaded from different terminal devices 20 are integrated and registered in association with the same action ID. Accordingly, the content server 11 allows a terminal device 20 that notifies the server 11 of the same action ID to access the integrated image data group associated with the same action ID. As a consequence, image data can be shared only between terminal devices 20 that can generate the same action ID.

Any digital rights management (DRM) technology such as the Marlin DRM may be used to determine whether to permit access to an image data group. For example, an image data group to be held in association with an action ID is encoded using a content key, and a license to access to the encoded image data group is generated. The license is granted only to a terminal device 20 holding therein the action ID associated with the image data group. The encoded image data group and the license are placed on any server. Accordingly, only a terminal device 20 holding the action ID associated with the image data group therein can generate a content key through a calculation and reproduce the image data group.

The present embodiment allows terminal devices to share image data. However, any content data including image data other than pictures, video data, audio data, an application program, etc., which is transmitted from the terminal devices 20-1 to 20-N, may be registered in the content server 11 in association with an action ID so that the content data can be shared.

### [Other Exemplary Uses of Action ID]

Considering the fact that terminal devices 20 that are located in the same place and the same time zone can only generate the same action ID, an action ID may be used as below.

### [First Exemplary Use: Control of Copyrighted Content Distribution]

An action ID may be used for service arranged to distribute, from a specified server, content data that can only be reproduced by people who have carried the terminal devices 20 to a concert hall, for example. The use of the action ID allows control to be performed so that only the people who have stayed in a certain place (in this case, the concert hall) over a certain time period can use the content data, for example. Further, an event where an idol and people act together over a certain time period may be held as premium service, and content data may be generated so that only the people who went to the event can obtain the content data, for example.

### [Second Exemplary Use: Substitute for Region Code]

In a media player configured to reproduce content data from a packaged medium such as a digital versatile disk (DVD), a Blu-ray Disc (BD), etc., a region code is set to restrict countries or areas where the media player can be used. A region code is also set for the packaged medium so that the packaged medium can be reproduced only when the region code of the media player agrees with the region code of the packaged medium.

Usually, the region code is set for a media player at the time of factory shipment. Therefore, when a media player is carried overseas, for example, it is difficult for the media player to reproduce a packaged medium obtained in that country or area. On the other hand, when a media player and a packaged medium of which region codes agree with each other are brought into a country or an area where the reproduction of the packaged media is not allowed, the packaged medium can be reproduced. That is, the set region code is often substantially ineffective.

Therefore, the media player may be configured to generate an action ID so that the generated action ID is used in place of a region code. As a consequence, it becomes possible to appropriately determine whether or not a packaged medium can be reproduced with the media player based on a country or an area where the media player is located. Therefore, the above-stated problems may be controlled.

### [Third Exemplary Use: Determination of Belonging to Home Network]

In the past, for sharing content data between, for example, plural audio visual (AV) devices that are connected to one another at home, which constitutes a home network, the Round-Trip Time, or the number of hops between the AV devices is used to identify the AV devices belonging to the home network. When a communication delay occurs in the home network for some reason, the AV devices belonging to the home network may be incorrectly identified.

Accordingly, action IDs may be used to identify the AV devices belonging to the home network, and the action IDs are transmitted between the AV devices. Content data is shared between the AV devices only when the transmitted action IDs agree with each other. As a consequence, it becomes possible to identify the AV devices belonging to the home network correctly and share the content data between the AV devices.

The above-described series of processes may be executed by hardware or software. When executing the processes by software, a program constituting the software is installed in a computer. Here, the computer includes a computer integrated into dedicated hardware, a general-purpose computer that can execute various functions through various programs installed therein, etc.

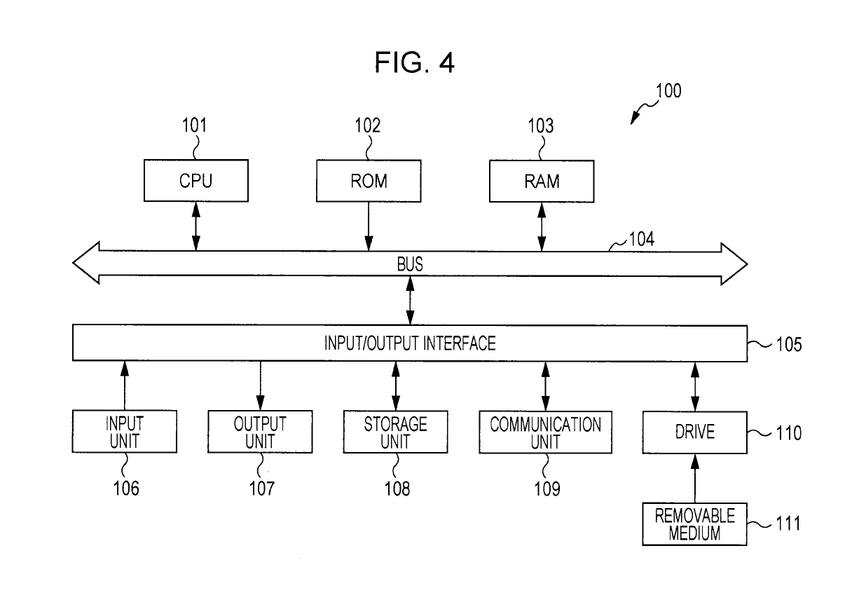

FIG. 4 is a block diagram illustrating an exemplary hardware configuration of a computer executing the above-described series of processes through a program.

In a computer 100, a central processing unit (CPU) 101, a read only memory (ROM) 102, and a random access memory (RAM) 103 are connected to one another via a bus 104.

An input/output interface 105 is further connected to the bus 104. An input unit 106, an output unit 107, a storage unit 108, a communication unit 109, and a drive 110 are connected to the input/output interface 105.

The input unit 106 includes a keyboard, a mouse, a microphone, etc. The output unit 107 includes a display, a speaker, etc. The storage unit 108 includes a hard disk, a nonvolatile memory, etc. The communication unit 109 includes a network interface and the like. The drive 110 drives a removable medium 111 including a magnetic disk, an optical disk, a magneto-optical disk, a semiconductor memory, and so forth.

In the above-described computer 100, the CPU 101 loads a program stored in the storage unit 108 into the RAM 103 via the input/output interface 105 and the bus 104, and executes the program so that the above-described series of processes is executed.

The program executed by the computer may be a program where processes are performed in time sequence according to the order described in this specification, or a program where processes are performed in parallel or at appropriate time such as when a call is issued.

Without being limited to the above-described embodiments, an embodiment of the present disclosure may be changed in various ways within the spirit and scope of the present disclosure.

The present disclosure contains subject matter related to that disclosed in Japanese Priority Patent Application JP 2011-250636 filed in the Japan Patent Office on Nov. 16, 2011, the entire contents of which are hereby incorporated by reference.

What is claimed is:

1. A terminal device comprising:
an acquisition unit configured to acquire time information and position information; and
a generation unit configured to generate an action identification based on acquired pieces of the time information and acquired pieces of the position information.

2. The terminal device according to claim 1, further comprising a transmission unit configured to notify an external device of the generated action identification, and transmit content data to the external device,
wherein the external device registers content data transmitted from different terminal devices in association with a same action identification that the external device is notified from each of the different terminal devices.

3. The terminal device according to claim 2, further comprising a reproducing unit configured to acquire and reproduce the content data associated with the action identification and registered in the external device.

4. The terminal device according to claim 2, further comprising:
an image pickup unit configured to generate image data; and
a holding unit configured to hold the generated image data,
wherein the transmission unit notifies the external device of the generated action identification, and transmits the image data held in the holding unit to the external device as the content data.

5. The terminal device according to claim 1, further comprising a measuring unit configured to measure the position information,
wherein the acquisition unit acquires the position information measured by the measuring unit.

6. The terminal device according to claim 3, wherein the content data is content data of which use is restricted based on the action identification.

7. The terminal device according to claim 1, further comprising:
an obtaining unit configured to obtain content data stored in a storage medium; and
a reproducing unit configured to reproduce content data,
wherein the reproducing unit determines based on the generated action identification whether or not to reproduce the content data.

8. The terminal device according to claim 1, further comprising:
a transmission unit configured to transmit a first generated action identification and content data to a different device belonging to a home network;
a reception unit configured to receive from the different device a second action identification that the different device has; and
a comparison unit configured to compare the first action identification and the second action identification,
wherein when the first and second action identifications agree with each other, the content data is shared between the different device and the terminal device.

9. An information processing method used for a terminal device, the information processing method comprising:
causing the terminal device to acquire time information and position information; and
causing the terminal device to generate an action identification based on acquired pieces of the time information and acquired pieces of the position information.

10. A program causing a computer to function as:
an acquisition unit configured to acquire time information and position information; and
a generation unit configured to generate an action identification based on acquired pieces of the time information and acquired pieces of the position information.

11. A storage medium storing a program causing a computer to function as:
an acquisition unit configured to acquire time information and position information; and
a generation unit configured to generate an action identification based on acquired pieces of the time information and acquired pieces of the position information.
